(19) United States
(12) Patent Application Publication
(10) Pub. No.: US 2023/0191857 A1
(43) Pub. Date: Jun. 22, 2023

(54) Self-Docking Cart

(71) Applicant: Hall Labs, LLC, Provo, UT (US)

(72) Inventors: David R. Hall, Provo, UT (US); Jerome Miles, Spanish Fork, UT (US); Jeffery Duncan, Tucson, AZ (US); Stephen Warren, Provo, UT (US)

(21) Appl. No.: 18/068,493

(22) Filed: Dec. 19, 2022

Related U.S. Application Data
(60) Provisional application No. 63/291,009, filed on Dec. 17, 2021.
(60) Provisional application No. 63/291,072, filed on Dec. 17, 2021.
(60) Provisional application No. 63/291,079, filed on Dec. 17, 2021.
(60) Provisional application No. 63/291,082, filed on Dec. 17, 2021.
(60) Provisional application No. 63/291,086, filed on Dec. 17, 2021.
(60) Provisional application No. 63/291,092, filed on Dec. 17, 2021.
(60) Provisional application No. 63/375,337, filed on Sep. 12, 2022.

(51) Int. Cl. B60D 1/00; B60L 53/36; B60L 50/60; B60K 7/00

(52) U.S. Cl. CPC B60D 1/00; B60L 53/36; B60L 50/66; B60K 7/0007; B60D 2001/005

(57) ABSTRACT

A self-docking, motorized cart, comprising: a body comprising a battery compartment and a platform; a battery housed in the battery compartment; a cart docking attachment arm; a controller; four arms, each pivotably attached at a first end to the body; four wheels, each connected to a second end of one of the four arms; four arm actuators, each configured to pivot one of the four arms such that each wheel can be moved closer to or further away from the body; wherein the controller adjusts the height of the cart by pivoting one or more of the four arms; and at least two motors, each configured to rotate one of the four wheels, each independently controlled by the controller, whereby the controller can move the cart and control the yaw of the cart by rotating one or more of the four wheels; whereby the cart can be moved into an appropriate position and orientation for connecting the docking arm attachment to a docking station by the controller selectively pivoting the arms and rotating the wheels; and wherein the docking attachment arm comprises connections for electricity or data is disclosed.

### CROSS-REFERENCE TO RELATED APPLICATIONS

This application claims the benefit under 35 U.S.C. § 119(e) of U.S. Provisional Patent Application Nos. 63/291,009 titled “Hitchable Cart” filed on 17 Dec. 2021, 63/291,072 titled “Motorized Utility Cart” filed on 17 Dec. 2021, 63/291,079 titled “Motorized Cart with Self-Leveling System” filed on 17 Dec. 2021, 63/291,082 titled “Motorized Cart with Automated Docking” filed on 17 Dec. 2021, 63/291,086 titled “Motorized Cart with Interchangeable Components” filed on 17 Dec. 2021, 63/291,092 titled “System for Attaching a Cart to a Vehicle” filed on 17 Dec. 2021, and 63/375,337 titled “Mobile Cart with Adjustable Cargo Container” filed 22 Sep. 2022, which disclosures are each incorporated herein by reference in their entireties.

### TECHNICAL FIELD

The present disclosure relates to self-propelled utility carts. More particularly, it relates to self-propelled utility carts useful for a variety of functions.

### BACKGROUND

Motorized carts are used for a variety of purposes in different environments. Many are suited to only a few tasks in a very controlled environment. This limits their usefulness and value. Such carts have fixed configurations that do not allow for adaptation to different functions. Typical carts require human effort to move and steer. They can also be inconvenient or difficult to transport to locations to be used, often requiring ramps and trailers or cargo space in a vehicle.

### SUMMARY

In a first aspect, the disclosure provides a self-docking, motorized cart, comprising: a body comprising a battery compartment and a platform; a battery housed in the battery compartment; a cart docking attachment arm; a controller; four arms, each pivotably attached at a first end to the body; four wheels, each connected to a second end of one of the four arms; four arm actuators, each configured to pivot one of the four arms such that each wheel can be moved closer to or further away from the body; wherein the controller adjusts the height of the cart by pivoting one or more of the four arms; and at least two motors, each configured to rotate one of the four wheels, each independently controlled by the controller, whereby the controller can move the cart and control the yaw of the cart by rotating one or more of the four wheels; whereby the cart can be moved into an appropriate position and orientation for connecting the docking arm attachment to a docking station by the controller selectively pivoting the arms and rotating the wheels; and wherein the docking attachment arm comprises connections for electricity or data.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of a first exemplary embodiment of a utility cart according to the present disclosure.

FIG. 2 is another isometric view of the first exemplary cart.

FIG. 3 is another isometric view of the first exemplary cart.

FIG. 4 is a side plan view of the first exemplary cart with one wheel raised and one lowered.

FIG. 5 is an isometric view of a first exemplary embodiment of a vertical offset adapter according to the present disclosure.

FIG. 6 is an isometric view of the first exemplary cart with the exemplary adapter of FIG. 5.

FIG. 7 is another isometric view of the first exemplary cart with the exemplary adapter of FIG. 5.

FIG. 8 is a top plan view of the first exemplary cart and of a first exemplary embodiment of a connector in a retracted position.

FIG. 9 is a top plan view of the first exemplary cart with the connector of FIG. 7 in an extended position.

FIG. 10 is an isometric view of the connector of FIG. 7 extended and of a first exemplary embodiment of a receiver according to the present disclosure.

FIG. 11 is another isometric view of the cart, connector, and receiver of FIG. 10 with the connector engaged with the receiver.

FIG. 12 is another isometric view of the embodiments of FIG. 10 with the wheels lowered to position the connector above the receiver.

FIG. 13 is another isometric view of the embodiments of FIG. 10 with the wheels raised to lift the cart off the ground when supported by the receiver.

FIG. 14 is an isometric view of the first exemplary embodiment of a connector and an exemplary embodiment of an electrical connector therein according to the present disclosure.

FIG. 15 is an isometric view of the first exemplary embodiment of a receiver and an exemplary embodiment of an electrical connector therein according to the present disclosure.

FIG. 16 is an isometric view of the first exemplary cart mounted on a vehicle with wheels elevated off the ground according to the present disclosure.

FIG. 17 is an isometric view of the first exemplary a cart mounted on a vehicle with wheels lowered to the ground.

FIG. 18 is an isometric view of a second exemplary embodiment cart of a utility cart with caster wheels and of a first exemplary embodiment of a utility component installed thereon according to the present disclosure.

FIG. 19 is another isometric view of a second exemplary cart and first exemplary component.

FIG. 20 is another isometric view of a second exemplary cart and first exemplary component.

FIG. 21 is an isometric view of the second exemplary cart and of a second exemplary utility component according to the present disclosure.

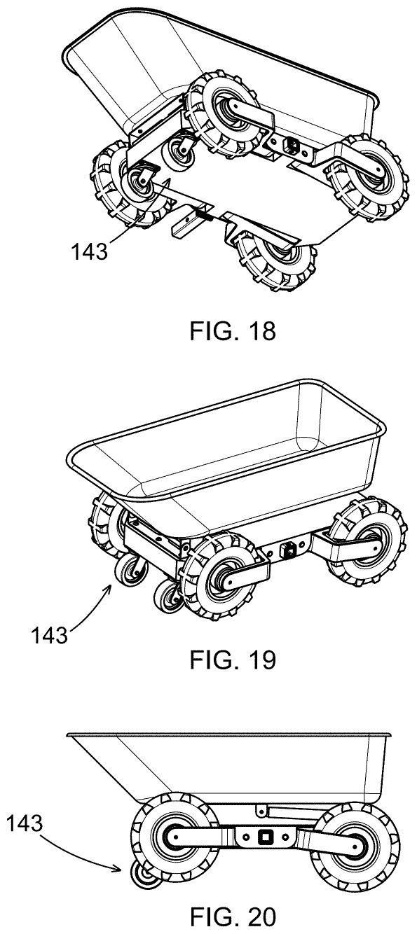

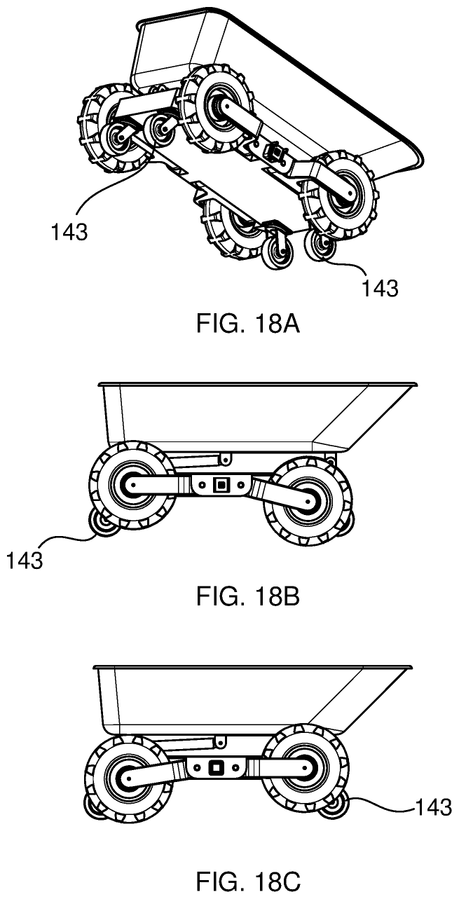

FIG. 18A is another isometric view of the second embodiment with additional caster wheels.

FIG. 18B is a side view of the embodiment of FIG. 18A.

FIG. 18C is another side view of the embodiment of FIG. 18A.

FIG. 22 is an isometric view of the first exemplary cart and the second exemplary component with extension arms extended laterally and longitudinally.

FIG. 23 is an isometric view of the first exemplary cart and the second exemplary component loaded with a sheet-like cargo.

FIG. 24 is bottom isometric view of the first exemplary cart and the second exemplary component loaded with sheet-like cargo.

FIG. 25 is an isometric view of the second exemplary component with end walls lowered.

FIG. 26 is an isometric view of the second exemplary component with end walls lowered and extensions with stops extended therefrom.

FIG. 27 is a side plan view of the first exemplary cart and the second exemplary component in a dumping position.

FIG. 28 is an isometric plan view of the first exemplary cart and the second exemplary component in a dumping position.

FIG. 29 is an isometric view of the first exemplary cart with an exemplary embodiment of a leash according to the present disclosure.

FIG. 30 is an isometric view of the first exemplary cart and leash of FIG. 31.

FIG. 31 is an isometric view of the first exemplary cart and leash of FIG. 31.

FIG. 32 is an isometric view of a third exemplary embodiment of a utility cart according to the present disclosure.

FIG. 33 is a top plan view of the third cart embodiment.

FIG. 34 is an isometric view of the third cart embodiment with two components attached to the bottom of the cart body.

FIG. 35 is a perspective view of an exemplary pair of Mecanum wheels.

FIG. 36 is an isometric view of an exemplary embodiment of a cart with a control stick according to the present disclosure.

FIG. 37 is an isometric view of an exemplary embodiment of a cart with a seat and basket according to the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

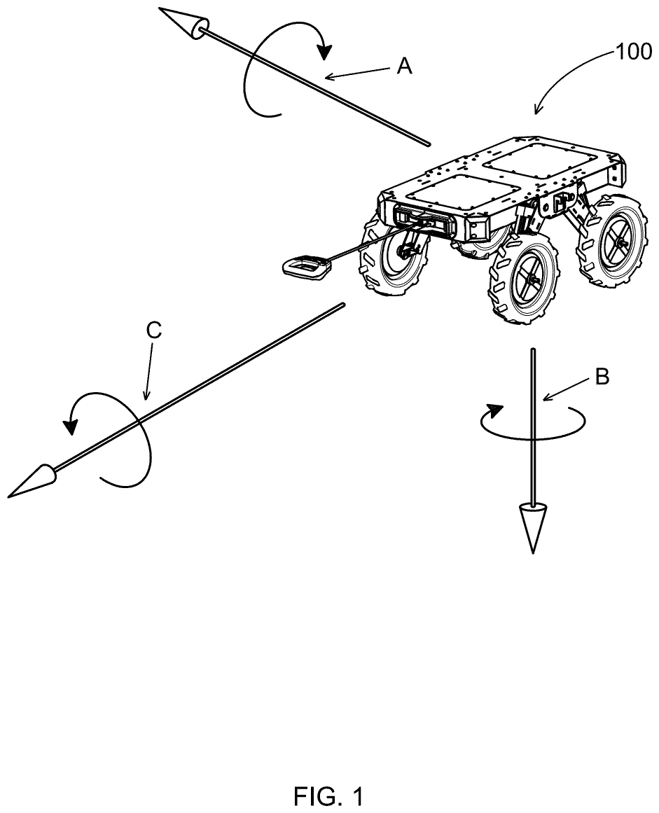

As used herein, “level” is meant to refer to the horizontal plane (i.e., perpendicular to the force of earth's gravity) or the position of a surface or object relative to the horizontal. In discussing level, the terms “pitch”, “yaw”, and “roll”, as they are commonly used (see FIG. 1), may be used to describe turns and deviations from the horizontal plane and adjustments made to the orientation of a cart. Pitch describes rotation around axis A in FIG. 1. Yaw describes rotation around axis B in FIG. 1. The term “steering” and similar terms may also be used to describe adjusting the cart's yaw. Roll describes rotation around axis C in FIG. 1.

As used herein, “docking” refers to the act of bringing the cart into contact with a base such as a charging or storage station. Docking may or may not involve securing the cart to the base.

As used herein, “hitching” refers to the act of securely attaching the cart to a vehicle to transport the cart. Hitching does not refer to towing the cart in that the cart's wheels are not intended to contact the ground at any time while the cart is hitched to and transported by a vehicle.

As used herein, a “component” is any device or equipment that can be attached to the cart to enable the cart to perform a function or to make a functionality mobile. Components are “interchangeable” in the sense that they can be attached to and detached from the cart, such that one may replace another or be added onto another.

As used herein, a “hitch receiver” or “receiver” is any mechanism on a vehicle to which the cart may attach. The receiver may be the vehicle's tow hitch receiver, typically used with a ball hitch. A receiver refers to the mechanism attached to the vehicle and to anything installed or engaged with it to facilitate hitching the cart to the vehicle.

As used herein, a “stored” or “stowed” component is placed in a location for long- or short-term storage, recharging, etc. and such that the cart can approach the component to engage it and secure it for use. A stored component may be placed on the floor, on a rack at an appropriate height, or below floor level, as needed.

### Exemplary Embodiments

The present disclosure relates to motorized, portable carts. More particularly, it relates to a motorized cart that is adapted for use with a variety of components that may include storage containers, work surfaces, personal support or transport devices, power tool, and functional equipment and machinery. It also relates to a motorized cart that is automated. The cart also includes an easy and convenient attachment to a docking station or a vehicle tow hitch (e.g., for charging or transportation). In various exemplary embodiments, a controller and one or more sensors are used to allow the vehicle to autonomously navigate around obstacles and reach destinations (e.g., to receive or deliver a load, to attach to a vehicle or docking station). The controller may also be configured to use GPS or other wireless signals to determine its position and navigate.

In various exemplary embodiments, the cart is powered by one or more electrical wheel motors. Preferably, the cart comprises one wheel motor in each of its four wheels. Each wheel motor is powered by one or more batteries, which are preferably rechargeable batteries.

In various exemplary embodiments, the cart is able to track its own location on a saved map and/or in relation to a starting position to which it may return. This may be accomplished through one or more of GPS position sensors, inertial sensors, and movement tracking. In various exemplary embodiments, the cart may use this information to navigate around a work site, or around a commercial, industrial, or residential building, or the like to perform a variety of tasks such as, but not limited to, landscaping (e.g., lawn mowing, leaf bagging, etc.), moving garbage cans, snow removal, transportation of materials or persons, or other tasks.

In various exemplary embodiments, the cart is adapted to be hitched to a vehicle for transport and/or to be docked to a station for recharging and storage. In some preferred embodiments, docking may include connecting to an electrical source (e.g., for charging a cart battery). In preferred embodiments, docking may include entering a bay, mounting a trailer, etc. In a preferred embodiment, the cart is at least semi-autonomous and able to travel to the docking location and attach itself either in response to programming (e.g., work schedule, scheduled battery recharges, low battery alert) or user/operator instruction. In preferred embodiments, the docking procedure is fully automated requiring no action or supervision by the user/operator.

In various exemplary embodiments, the cart is adapted for direct attachment to a vehicle's hitch system for transportation. In a preferred embodiment, the cart has a connector adapted to engage a receiver device installed in the car. The connector is preferably slidably held in a sleeve attached to the cart such that the connector can be stored (entirely or nearly entirely) in the sleeve when not in use. In another embodiment, a connector bar is slidably received in a sleeve or tube affixed to the body of the cart and to fit into the vehicle's hitch receiver. The sleeve may be simply attached to the bottom of the cart's body or may be incorporated within the body itself. In a preferred embodiment, the sleeve traverses the width of the cart allowing the connector bar to be extended from either side.

In a preferred embodiment, the cart also connects electrically to the vehicle. This connection may be used to charge the battery and/or to operate running lights, turn signals, etc. on the cart if the corresponding lights on the vehicle are blocked or obscured by the cart or its contents. In preferred embodiments, the electrical connection is built into the mechanical connection. In other embodiments, a separate connection is used, which may be automatically or manually connected.

In various exemplary embodiments, the system is able to automatically keep the platform level. However, in some situations, it may be advantageous for the cart to deviate from level. For example, when the cart is engaging or disengaging with a vehicle tow hitch, it is important for the cart and tow vehicle to be at the same angle with respect to a horizontal plane, so that the connector will properly engage the vehicle receiver.

In various exemplary embodiments, one or more electric motors are used to power one or more tires. In a more preferred embodiment, individual motors are provided for each of two or four of the wheels for separately driving each wheel. Most preferably, a wheel motor is for each of the four wheels of the cart. In preferred embodiments, the motors that actuate the wheels are located in the wheel hub. In preferred embodiments, geared hub motors are used in either two or four of the wheels. Motors or other actuators are also included for actuating the pivot arms to raise and lower the wheels or cart platform. In a preferred embodiment, the cart includes at least one battery that provides power to the motors and actuators. In a more preferred embodiment, the battery is a rechargeable battery.

Now referring to FIG. 1, an exemplary embodiment of a mobile, self-propelled utility cart 100 is shown. In various exemplary embodiments, the cart 100 has four wheels 141, each of which are attached to the end of an arm (or leg) 140 that is articulatably (e.g., pivotally) attached to the cart's body or frame 120. In preferred embodiments, each of the arms 140 is pivoted by an actuator 142 (e.g., a linear or rotary motor) such that the wheel 141 is raised or lowered (i.e., the platform may be lowered and raised) relative to the body. In various exemplary embodiments, the actuator 142 is a linear actuator, such as a piston or screw drive, that is pivotally attached to the cart body at one end and to the arm or wheel hub at the other end to pivot the arm up and down.

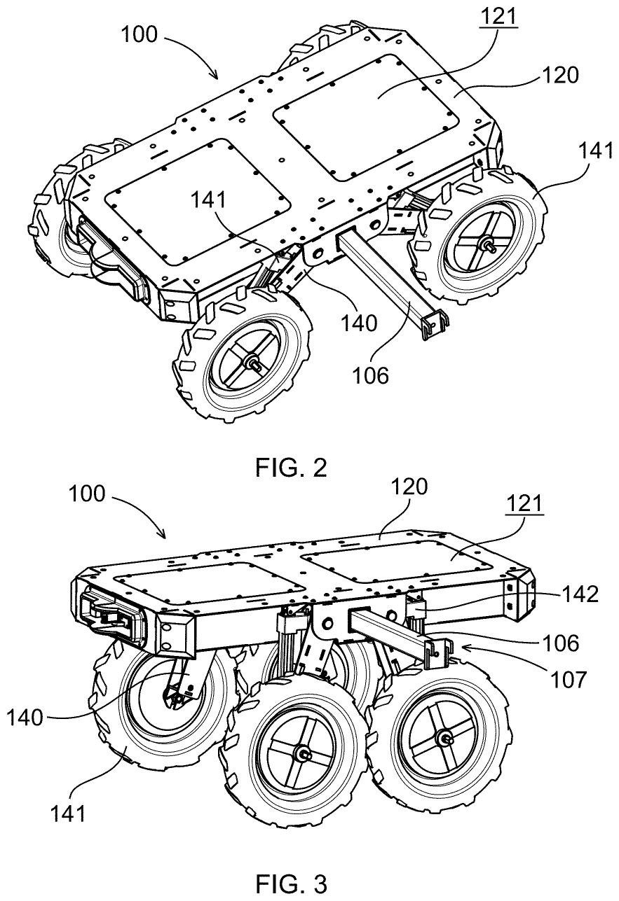

Now referring to FIGS. 2 and 3, the cart 100 is shown with the body 120 lowered and raised, respectively. In addition to raising and lowering the connector 106 for attachment to a vehicle, the body 120 may be raised or lowered to facilitate addition of components to the cart, loading and unloading cargo, and for optimal movement. In various exemplary embodiments, the cart's wheels 141 are mounted on arms 140 pivotably or rotatably attached to the cart body 120. The arms may be rotated or pivoted by a motor that turns the arm 140 at the pivot joint or by a linear actuator as discussed above.

In various exemplary embodiments, the arms themselves can be extended and retracted, e.g. by providing a “telescoping” length adjustment on the arms. In this way, the cart has an even greater height adjustment range. Such greater range can be advantages, particularly where the cart is adapted to climb stairs and the like. In these embodiments, the arms may include arm extension actuators (e.g., a piston or screw drive) that can extend and retract to lengthen or shorten the total length of the arms. This increases the height to which the platform may be raised and the tilt angles that can be achieved and can also provide a longer wheelbase for better stability.

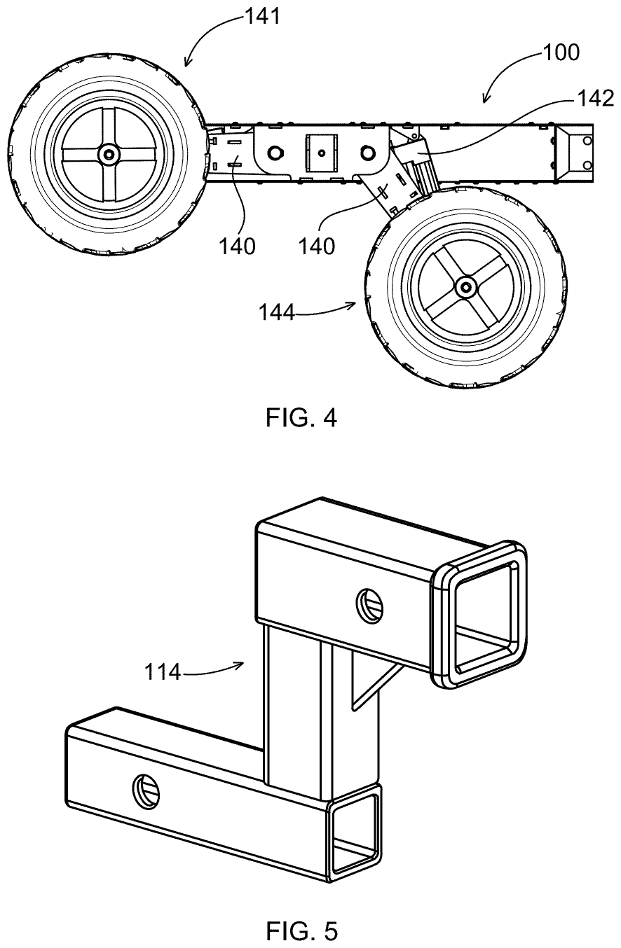

Now referring to FIG. 4, the cart is displayed with one pair of wheels 141 raised and the other pair of wheels 144 lowered. In a preferred embodiment, at least one sensor 123 (see FIG. 32) is used to detect if the orientation of the platform 121 is not horizontal and control the pivot arm actuators 142 to adjust the wheels 141, 144 to maintain it at level with the horizontal plane. A single sensor 123 may be used to monitor pitch and roll or separate sensors for each. In a preferred embodiment, the wheels 141 are designed to be able to climb uneven terrain and obstacles such as ramps, curbs, steps, stairs, etc. and adjust the tires relative to the platform to maintain it at level. This may be beneficial for passengers or cargo carried on the cart.

As shown in FIG. 4, the arm actuator 142 is a linear actuator (e.g., a piston or screw drive) pivotally attached at a first end to the body 120 at a point near to where the arm 140 is attached to the body. The second end of the actuator 142 is attached to the arm 140, preferably at or near the attachment of the arm to the wheel, or to the wheel hub. Extending or retracting the linear actuator pivots the wheel away from or toward the body, thus raising and lowering the cart, respectively.

Now referring to FIG. 5, a vertically offset adapter 114 to adjust the height of the cart relative to the vehicle tow hitch receiver is shown. In a preferred embodiment, the adapter 114 is used to attach the cart to tow vehicles with relatively high or low hitch receivers. In various exemplary embodiments, the adapter 114 is designed to attach to a connector on the cart bar on one end and to the tow vehicle hitch receiver on the other end. In a preferred embodiment, the adapter 114 is connected using a pin, bolt, or other fastener. In a preferred embodiment, the locking mechanism is automated and locks into place once the system is in position.

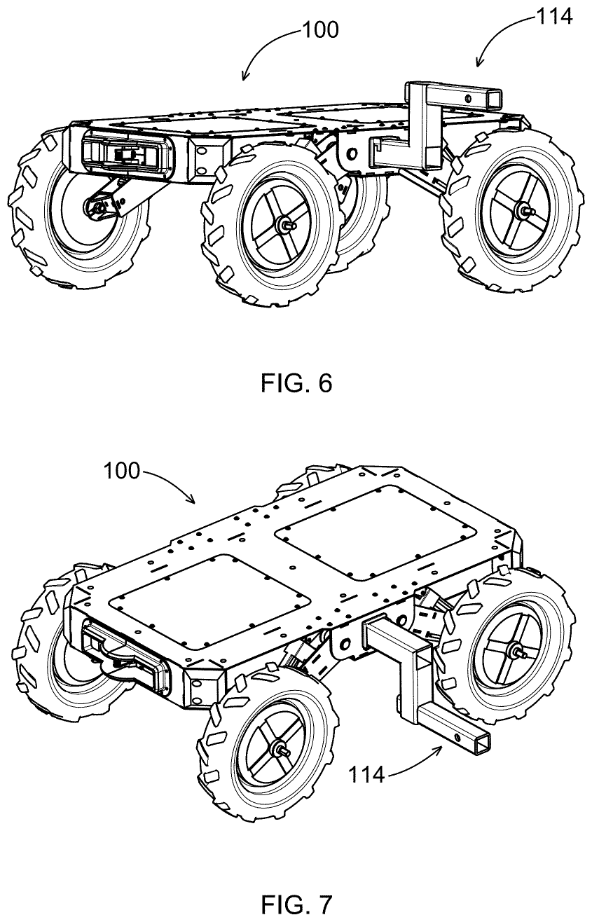

Now referring to FIGS. 6 and 7, the vertically offset adapter 114 is show attached to the cart in one each of two positions. In FIG. 6, the adapter 114 is in position to lower the position of the cart relative to the tow vehicle. In FIG. 7, the adapter 114 is in position to raise the height of the cart relative to the tow vehicle. Different embodiments of the adapter may have different dimensions, particularly as to the height offset achieved. The preferred offset distance may vary based on vehicle hitch height (i.e., vehicle height) and the diameter of the wheels on the cart.

In the case of a low-riding vehicle, the adapter may be used to attach the cart at a sufficient height off the ground to ensure that the cart's wheels do not touch the ground. This may be especially important on uneven surfaces or when crossing a dip, such as a storm drainage channel or when entering/exiting a parking lot or driveway. The necessary clearance may depend on the choice of tires (i.e., wheel diameter) for the cart.

In the case of an elevated tow vehicle, the adapter makes it possible to attach to a hitch receiver that it is at too great a height for the cart. It may also facilitate loading and unloading the cart while attached to the tow vehicle.

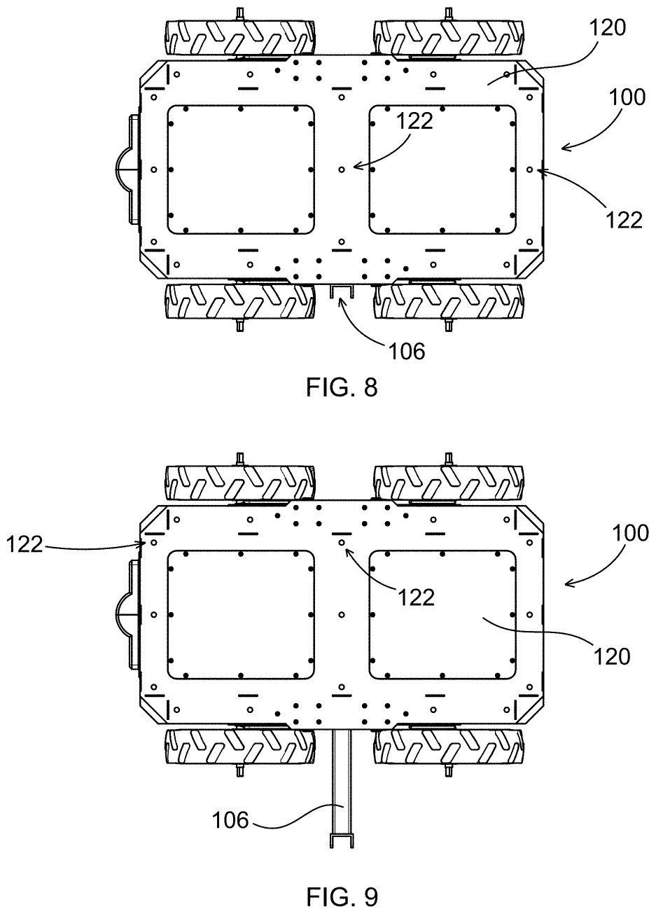

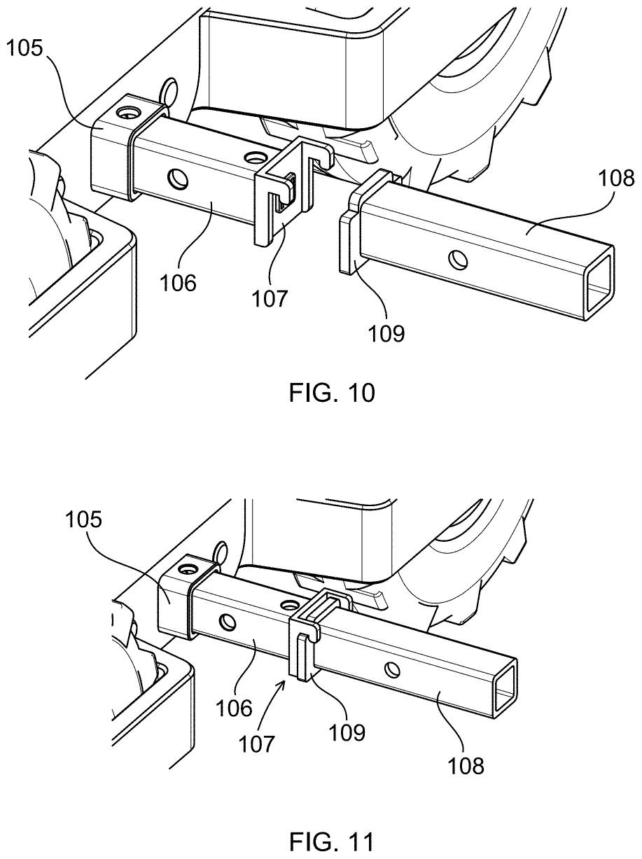

Now referring to FIGS. 8-9, the cart 100 is shown with an adjustable connector bar 106 in retracted and extended positions, respectively. In a preferred embodiment, the connector includes a tube sleeve 105 and a connector bar 106 that slidably fits therein. As seen in FIGS. 10-11, in preferred embodiments, the connector bar 106 includes a bracket 107 that is adapted to fit with a flange 109 in the hitch receiver 108. In other embodiments, the connector bar 106 is adapted to fit directly into the hitch mount of a tow vehicle in the same manner that a ball hitch or the like would be attached to the vehicle.

In FIG. 8, the connector bar 106 is fully retracted into the sleeve 105. In FIG. 9, the attachment connector bar 106 is extended out from the receiving member. In each case, the connector bar is fixedly locked in place with a pin, bolt, or other fastener. In a preferred embodiment, the locking mechanism is automated. This allows for storage of the connector bar when not in use and for extension of the connector bar to a plurality of lengths as appropriate for the tow vehicle. Many tow vehicles have spare tires, bicycle racks, or the like mounted on the back of the vehicle necessitating a longer connector bar to enable connection to the vehicle without removing the spare tire or other item.

In some exemplary embodiments, the attachment connector bar is manually adjusted and locked in place. In other exemplary embodiments, the connector bar is mechanically adjusted either manually (e.g., by using a hand crank) or is automated (e.g., moved by a motor or other actuator).

In various exemplary embodiments, an adapted vehicle hitch receiver 108 is used to attach to the cart connector 106. Referring to FIGS. 10-11, various preferred embodiments include a hitching system with a connector arm or bar extending outward from the cart having a hitch on the end. The hitch includes a bracket 107, preferably comprising two downward facing channels (e.g., hooks) adapted to engage with a flange 109. A receiver arm or bar 106 is attached to the towing vehicle and includes a flange 109 adapted to receive the brackets 107. In FIG. 10, the hitching system is shown disconnected. In FIG. 11, the hitching system is shown connected.

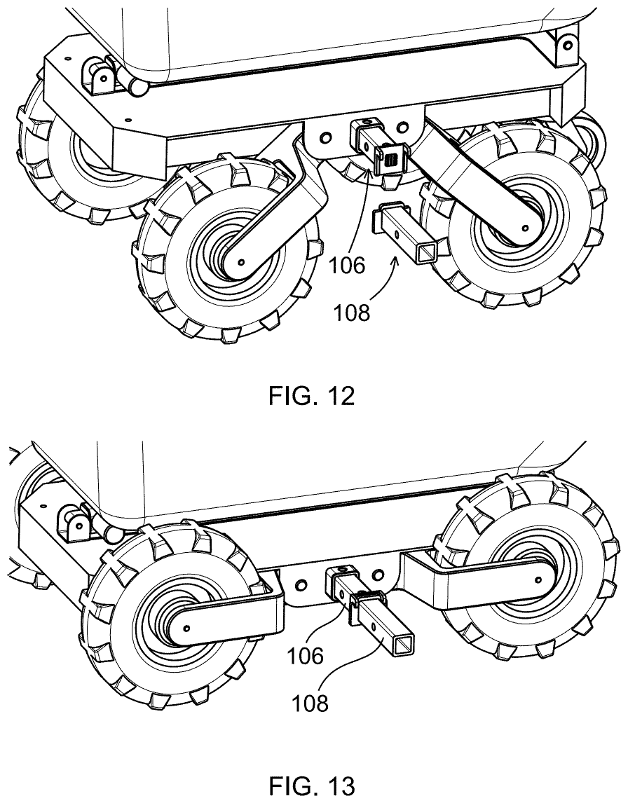

The process for engaging the bracket 107 and flange 109 is shown in FIGS. 12-13. The cart body 120 is raised to a height where the bracket 107 is higher than the flange 109 and the cart moves to position the bracket above the flange. In preferred embodiments, the bracket 107 includes a sloped or angled tip to facilitate lowering the cart body such that the bracket 107 lowers onto and engages the flange 109. In various exemplary embodiments, the bracket and flange may be locked together with additional mechanisms such as pins, bolts, or latches. The cart body is raised to reverse the process and disengage the hitching mechanism.

In a less preferred embodiment, the connector comprises a bar 106 that is connected to the body, preferably in a sleeve 105 as described previously, that is adapted to slide directly into the vehicle receiver 108.

In various exemplary embodiments, an electrical connection between the vehicle and cart is provided. This may be part of the hitch mechanism or a separate feature (e.g., a manually connected power cable). The connection may power lights on the cart, such as taillights, signal lights, brake lights, etc., that mimic those on the vehicle. This may be necessary in situations where the vehicle and cargo obstruct or obscure vehicle lights.

In various exemplary embodiments, the cart is designed to connect with docking stations. In a preferred embodiment, the connection may be a secure mechanical connection, such as described above for a vehicle hitch. In a preferred embodiment, the connection also includes an electrical connection. The electrical connection may provide current for charging a cart battery.

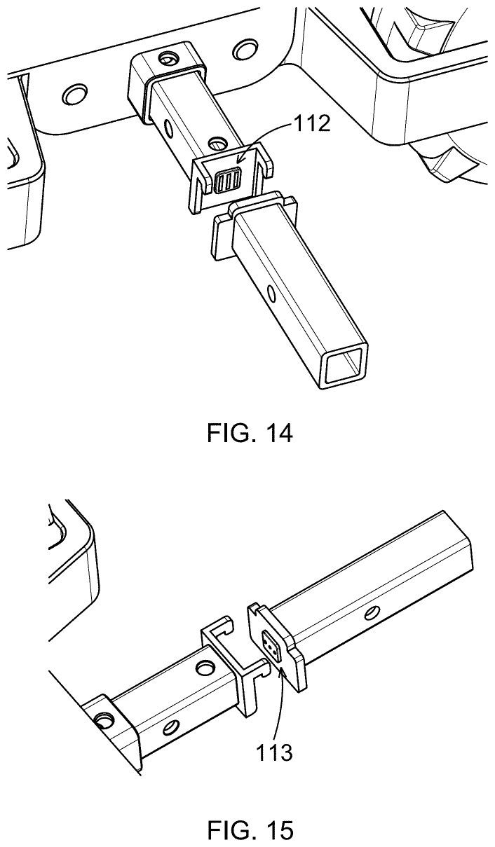

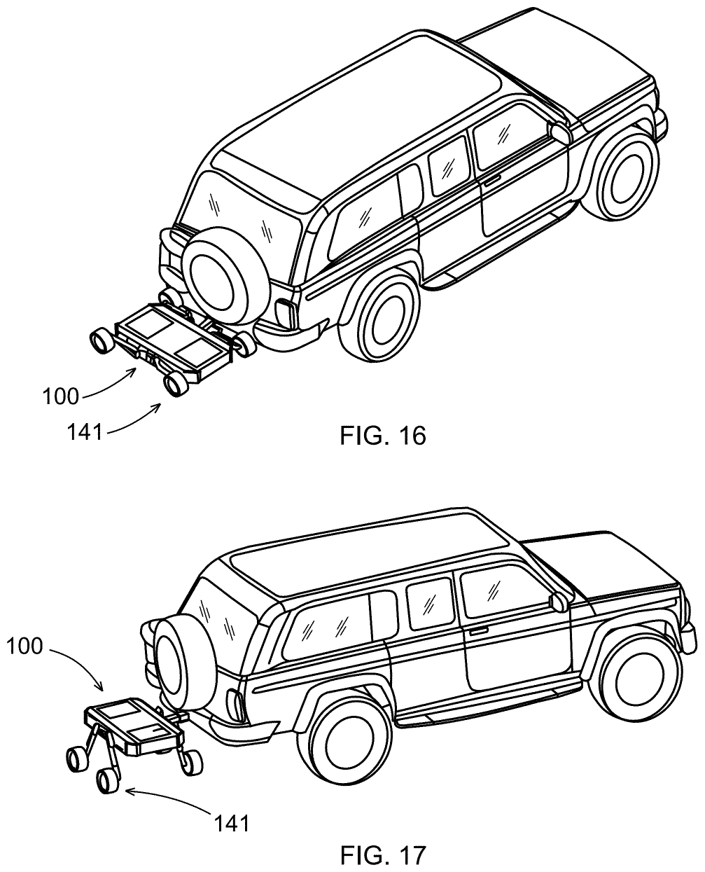

Referring to FIGS. 14-15, an exemplary embodiment of a connection including an electrical connection is shown. The mechanical connection is the same type as shown above in FIGS. 10-13. The connector includes electrical connectors. In a preferred embodiment, three electrical connectors (e.g., positive, negative, and ground) are provided. The vehicle hitch includes matching electrical connectors.

In a preferred embodiment, the electrical connectors 112 on one component are arranged in vertical lines (see FIG. 14). The electrical connectors on the other component are smaller pins 113 (see FIG. 15). This arrangement provides tolerance for the electrical connectors to engage without a precise vertical alignment fit. It also helps to maintain the connection when the vehicle is jostled by bumps, dips, etc. during transport. In various exemplary embodiments, there is one or more additional latching or locking mechanisms holding the connector bars together. These may include a bar or latch extended from the cart connector bar under or into the vehicle connector bar.

Now referring to FIGS. 16-17, an embodiment of a portable cart 100 is shown hitched to a vehicle. In FIG. 16, the cart's wheels are raised off the ground for vehicle transport. In FIG. 17, the cart's wheels are lowered to the ground. In preferred embodiments, the wheels may be raised and lowered (i.e., the platform may be lowered and raised) to facilitate easy mounting of the cart to a vehicle hitch.

In various exemplary embodiments, the cart is equipped to connect to components on racks by positioning itself or a portion thereof under the component and then raising itself into contact with the component of a portion thereof, securing the component, and raising itself to lift the component off the rack. A component may be above a bay known to the cart. A bay may also function as a cart storage space and include an electrical connection to which the cart connects for charging the battery. Components may also be stored at a known location and engaged by the cart approaching them, engaging them, and lifting them off the ground. This includes components that attach on top of the platform (e.g., barrow), under the platform (e.g., lawnmowers, leaf baggers), and/or to the end or hang over the edge of the platform (e.g., snow blowers or plows).

In various exemplary embodiments, at least two of the wheels are omni-wheels (omnidirectional wheels) or, more preferably, Mecanum wheels. As shown in FIG. 35, the preferred Mecanum wheel is a tireless wheel, with a series of rubber coated rollers obliquely attached to the circumference of the rim. The rollers have an axis of rotation that is 45° to the wheel plane and 45° to the axle line. Each Mecanum wheel is an independent non-steering drive wheel with its own powertrain, preferably a hub motor. When spinning, the wheel generates a propelling force perpendicular to the roller axle. These forces can be vectored into a longitudinal and a transverse component in relation to the vehicle.

The use of omni-wheels (i.e., omnidirectional wheels) or Mecanum wheels enables the widest range of motion for the cart, including the ability to move sideways. Sideways movement is particularly useful for docking and undocking with a transport vehicle hitch. To detach, the wheels are lowered sufficient to take the weight of the cart and the cart moves parallel to the hitch shaft to pull away from the tow vehicle and separate from the tow hitch receiver. To attach, the cart is motored into position behind the vehicle and the body elevated to match the hitch shaft to the level of the tow hitch. The cart then moves to engage the hitch shaft with the tow hitch receiver.

In preferred embodiments, simpler wheels, such as with pneumatic tires are used. Steering with simple wheels is accomplished by independently controlling the wheel motors. For example, tank or skid steering can be utilized.

In various exemplary embodiments, the cart is directed by turning the wheels on one side of the vehicle faster than the wheels on the other side of the vehicle, by turning the wheels on only one side, or by rotating the wheels on each side in opposite directions (i.e., skid steering). The greater the difference in rotation, the tighter the turn including rotating in place. One undesirable effect of this is that the wheels can rub or grind on the ground, which can damage flooring or plants (e.g., grass lawns). For use on such surfaces, two of the motorized wheels may be replaced by caster wheels, as described below.

Now referring to FIGS. 18-20, the cart includes a pair of caster wheels 143. In some embodiments, the casters 143 may be raised or lowered from under the cart. In other embodiments, the caster wheels 143 are fixedly attached and only come into contact with the ground when wheels are raised above the level of the caster wheels. In a preferred embodiment, the casters are detachably attached to the cart and may be easily removed when not needed for the cart's intended use. In one embodiment, a pair of caster wheels are located at about the corners at one end of the cart. In some embodiments, as shown in FIGS. 18A-C, the cart includes a second pair of caster wheels. In various embodiments, caster wheels are mounted on arms or legs that raise and lower them as needed.

In such an embodiment, the cart is capable of moving without the need for skid steering. Rotating the motorized wheels at different rates will cause the cart to turn without skidding on the floor. In other embodiments, the cart includes four casters. With four casters, the wheel can be lifted up so that the cart may be manually pushed and steered, which may be desirable in some environments and/or loading scenarios.

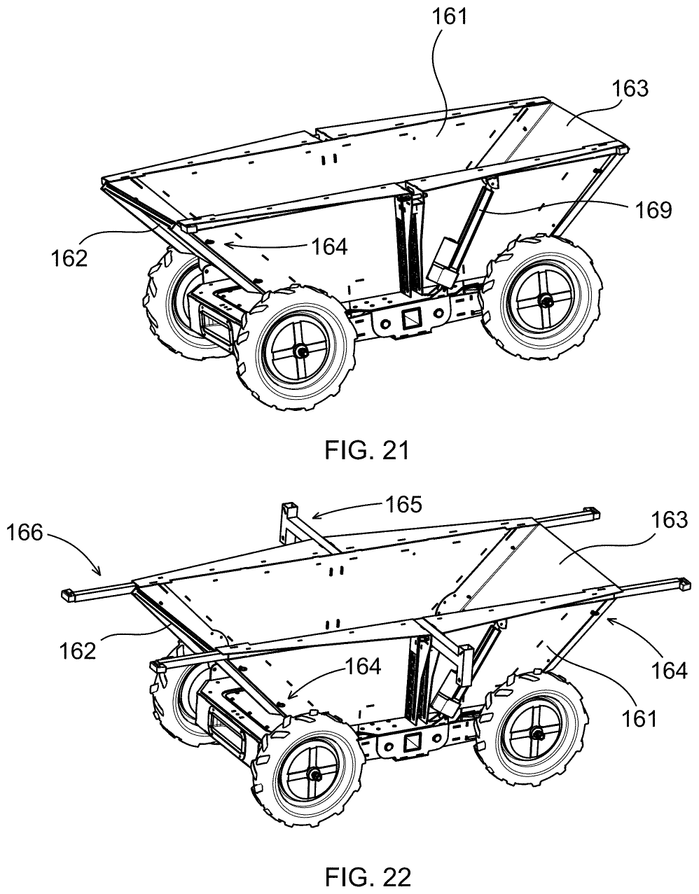

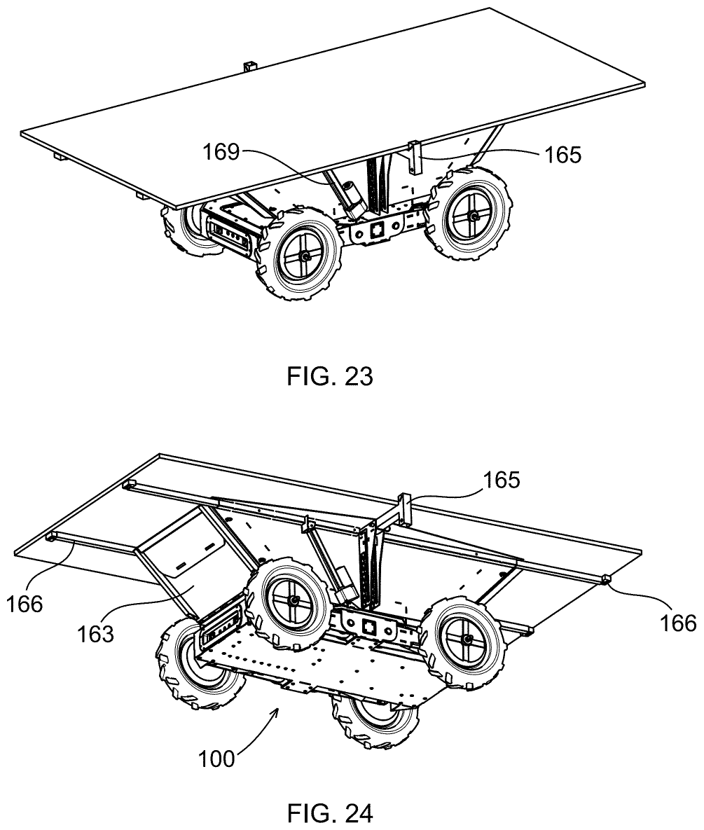

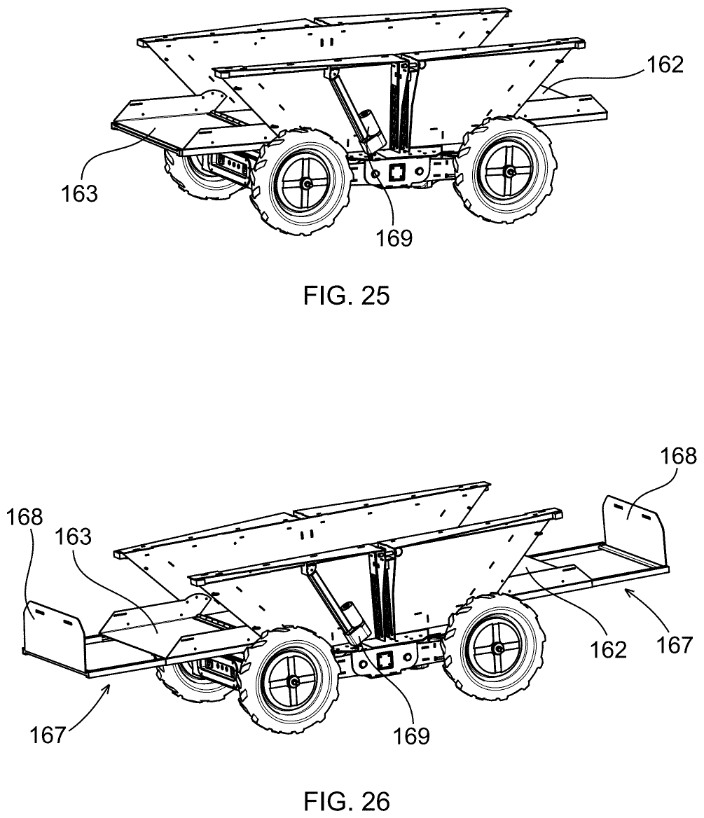

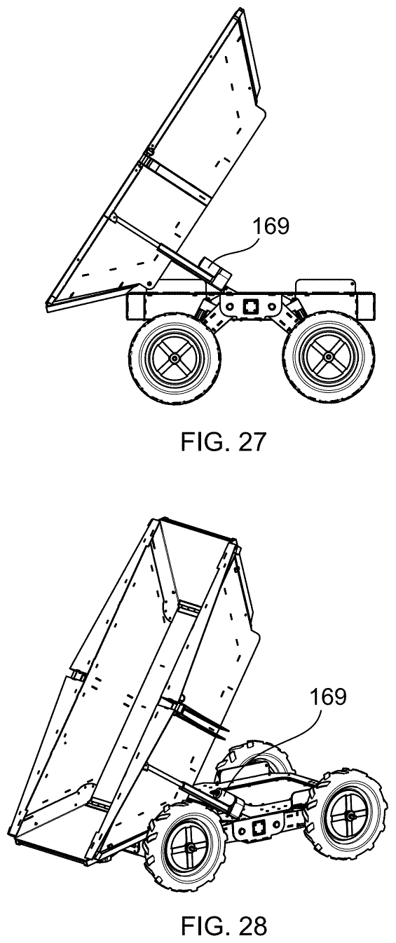

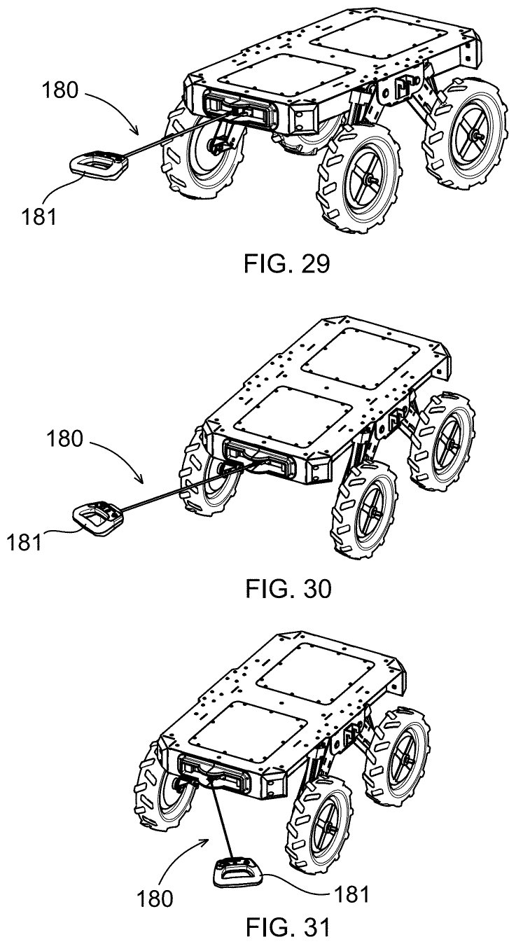

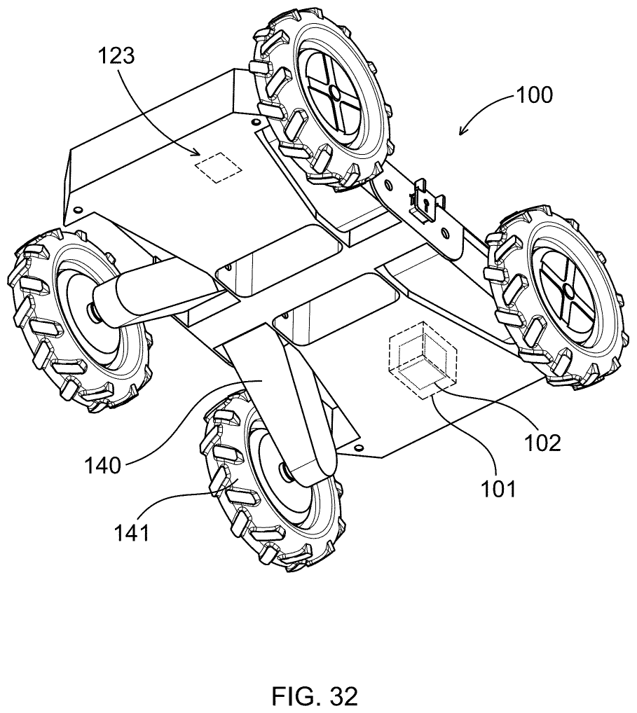

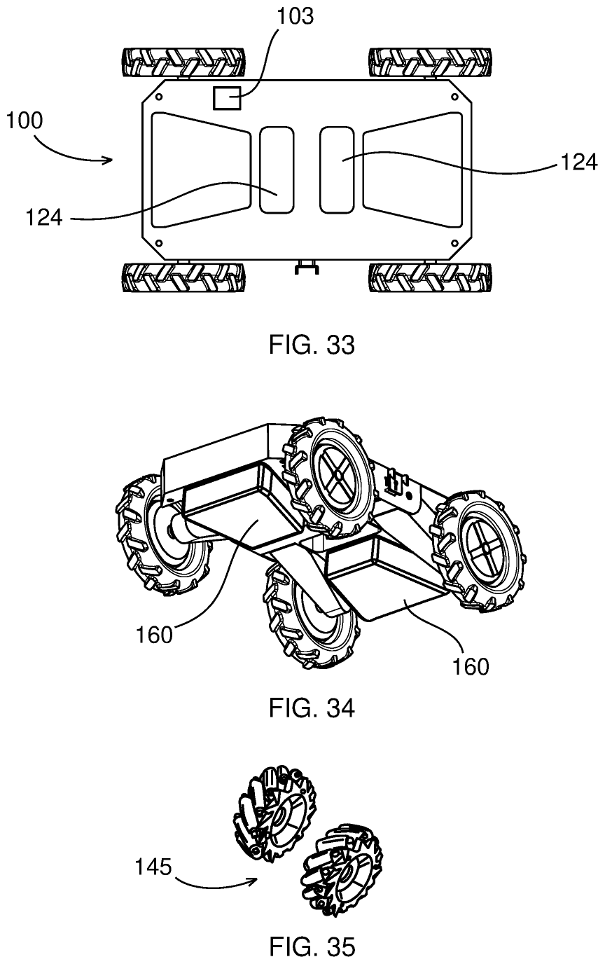

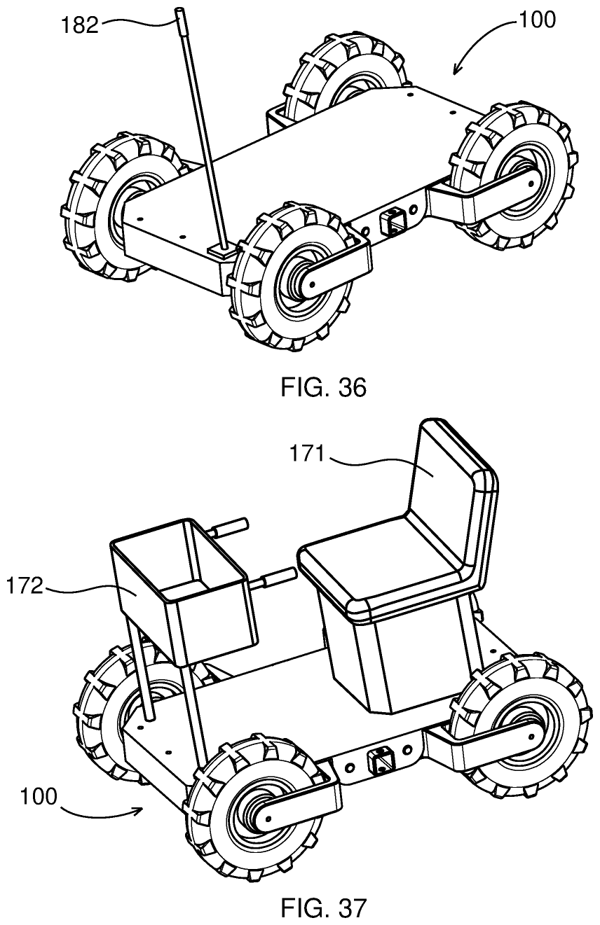

In various exemplary embodiments, the cart is equipped with an adjustable barrow or container capable of different configurations for differently shaped or sized loads. Now referring to FIG. 21, an exemplary embodiment of a cargo attachment 160 is shown in one configuration. The component 160 comprises two side walls 161 and two end walls (a front end wall 162 and a rear end wall 163). In this configuration, there is a single compartment able to receive cargo, including loose cargo like gravel. In some embodiments, a center piece (not shown) may divide the compartment in half. The center divider may be sized to provide support to carry objects, like lumber, on top of the side walls above the barrow.

Referring now to FIG. 22, an exemplary embodiment of the cargo attachment 160 includes side arms 16 that may be lifted up to the level of the top of the sidewalls. The ends of the side walls are equipped with extending arms 166 that are at the same height. Now referring to FIGS. 23-24, the configuration of FIG. 22 is shown carrying a large, thin, sheet-like material such as sheets of plywood or drywall.

Now referring to FIGS. 25-26, the configuration of the cargo area is altered by laying down the end walls 162, 163 to extend the length of the flat bottom, which may include stops at the end. In FIG. 25, the front and rear end walls 162 and 163 are lowered to a position generally parallel to the bottom of the component. In FIG. 26, the end walls include extenders 167 and stops 168. This configuration is useful for carrying objects like lumber and/or boxes. In a preferred embodiment, the end pieces are adjustable to vary the length of the cargo area.

Now referring to FIGS. 27-28, the cargo carrier is connected to the cart such that it is capable of dumping its cargo. In a preferred embodiment, a piston or similar actuator 169 between the cart and the cargo container is included to lift the carrier and dump its cargo. In order to facilitate dumping, the wheels at the front and/or rear of the barrow may be raised or lowered.

In various exemplary embodiments, the wheels may be removed and replaced with different size or type wheels. The wheels may vary in diameter, width, or tread type depending on the desired use or environment (e.g., indoor/outdoor, floor surface, load weight). Currently, pneumatic tires, with a tread suitable for navigating indoors and outdoors, are preferred.

In other exemplary embodiments, the arms on which the wheels are mounted are designed for easy removal for switching wheels. In some such embodiments, the arms are attached to the cart with one or more pins, bolts, or other fasteners.

In various exemplary embodiments, the cart is able to follow a user. In some embodiments, the cart may be drawn by a leash that is able to detect a distance and direction of a handle, which is held by the user. This information is used to track the user's location at all times to record and then follow the same path as the user (possibly avoiding obstacles or surfaces on which it should not travel).

In various exemplary embodiments, the cart includes a controller that operates the motors to steer the vehicle. The connection may be wired or wireless. In a preferred embodiment, the controller is able to record and store routines (i.e., how to navigate paths, climb stairs), including navigating turns and raising/lowering the wheels/platform to maintain the platform at level climbing stairs and curbs or other crossing other obstacles or non-level surfaces.

In various exemplary embodiments, the system includes a processor, a memory module, and a position module. In preferred embodiments, the position module records adjustments made by the cart to maintain a level condition over a given path. Further, the processor is configured to provide instructions to the controller to make the same adjustments when the cart travels the same path or to make the adjustments in reverse order when returning along a previously traveled path.

In various exemplary embodiments, a remote-control device is connected to the controller to instruct on how the cart should move. In preferred embodiments, the remote-control device connects wirelessly to the controller. In a more preferred embodiment, the cart includes a docking station for the remote-control device. The docking connection may include a charging connection for a remote-control battery and a wired data connection to the controller. In less preferred embodiments, the remote control is part of a cart leash handle of the type shown in FIGS. 29-31 and discussed below.

Now referring to FIGS. 29-31, an embodiment of a cart 100 with a leash control system is shown. In various exemplary embodiments, the leash system uses a cable 180 of known length around a spool. In a preferred embodiment, the leash 180 is retracted when not in use. In preferred embodiments, the spool is incorporated with a leash handle 181 and is not on the cart body. In a preferred embodiment, an encoder records the rotations of the spool and sends that data to the controller. The distance from the spool to the handle may be measured based on the number of spool rotations when the leash is unspooled, which may be unspooled less than its entire length. The spool may communicate wirelessly with the controller or via wired connection in the leash.

In a preferred embodiment, as illustrated in FIGS. 29-31, the leash 180 is pivotally attached to the cart. This connection rotates as the leash 180 is pulled different in directions from the cart 100. In various exemplary embodiments, the leash system allows the handle to be pulled out until a minimum safe distance, which may be chosen by the user, is reached. At this point, pulling the leash out more instructs the cart to begin moving forward. As the leash is pulled more, the cart increases speed until a maximum speed is reached. If the leash is allowed to retract back past the trigger point, the cart will stop moving.

In various exemplary embodiments, the cart has two travel modes. In an active control mode, the cart responds immediately to movements of the handle. This is most useful in situations where the user needs to closely control the cart and not be followed by the cart (e.g., when storing the cart or hitching it to a two vehicle). In an intelligent travel mode, the cart uses data from the control system to follow the path traveled by a user (e.g., turning where and not when the user turns). In various exemplary embodiments, the cart may also be capable of being put in park and/or neutral modes.

In some embodiments an encoder records partial rotation of the spool and sends this data to the controller. The data from the spool and from the leash connection are used to constantly determine and track the movement of the handle and, thereby, the movement of the user.

In other exemplary embodiments, the system may track a user by tracking a device carried by the user (e.g., a phone or remote) using accelerometers and other sensors or systems, such as GPS, to track and follow the user.

In various exemplary embodiments, the system also includes a manual controller (e.g., one or more buttons and/or joysticks) used to direct the cart. This may be incorporated into the leash handle or may be separate therefrom.

In various exemplary embodiments, the cart records the position of the handle as it is moved by the user to calculate a path to follow the user. In a preferred embodiment, the cart attempts to follow the path of the user, as determined by handle position, rather than always moving directly in the direction of the user/handle. This allows the cart to avoid obstacles avoided by the user and to keep it from cutting across corners when the user changes directions.

In various exemplary embodiments, the system is able to detect changes in unspooled leash length as user starts, stops or pauses, and changes in pace and react accordingly.

Referring to FIGS. 32-33. another embodiment of a cart is shown. In various exemplary embodiments, there are one or more openings 124 through the body of the cart. These may be used to provide electrical, mechanical, or other connections between components on top and on the bottom of the cart. For example, a lawn mower attachment on the bottom of the cart could be powered by a motor on top of the cart and/or could pull grass cuttings into a bag on top of the cart.

In various exemplary embodiment, the cart platform is designed to be a support for a variety of components. In various exemplary embodiments, the platform includes a plurality of connection points for components of different sizes or configurations. In various exemplary embodiments, the plurality of connection points includes multiple points where the component is secured to the platform. The plurality of connection points also includes electrical connections for power and/or data. Not all components will need or use all the connection points. For example, simple storage containers may not need electrical or data connections while heated or cooled containers may need to be powered and have settings to be set and controlled. Also, by way of example, a seat may not use all the mechanical connection points because its footprint is smaller than that of the platform.

The components may be attached above or below the platform and may extend over the edges of the platform (e.g., a snowplow attachment) The components may include one or more of seats, chairs, beds, toolboxes, tabletops, worktables, open or closed storage compartments (which may be heated or refrigerated), robotic arms, fuel tanks, water tank, oxygen tank, barrows, garbage can grapplers, lawn mowers, snowplows, snow blowers, skid plates for moving garbage cans and other containers, strollers, office chairs, human carriers (e.g., converting the cart into a motorized scooter or bed), and the like. In various exemplary embodiments, components may also be attached to the underside of the cart. In some embodiments, a space 124 in the cart is reserved for connections between component above and below the cart. The connections may be fluidic, electronic, or mechanical. For example, a lawnmower attached below the cart may be driven by a motor attached above the cart body via a shaft and/or other mechanical connections.

In various exemplary embodiments, as shown in FIG. 36, the cart is equipped with a control stick 182. An operator pushes the control stick in the desired direction of movement and the cart moves accordingly. In such embodiments. the control stick 182 is adapted for use by an operator walking along with the cart or standing thereon. In a preferred embodiment, the system includes a safety mechanism to prevent the cart from moving because of incidental or accidental contacts with the control stick. For example, the stick handle could include a trigger or switch that must be held down or sensors for detecting a user's hand for it to operate. In other exemplary embodiments, a smaller joystick, which may or may not be affixed to the cart, may be used (e.g., when used as a remote).

In a preferred embodiment, as shown in FIG. 37, the cart is equipped to have a component such as a seat 171 and a basket 172. The seat preferably rotates at its base to facilitate a person's getting on and off. In some embodiments, the seat is equipped with a belt or harness to keep the rider safely in place. A basket is preferably provided for carrying items for the rider. An expanded platform may be used to create sufficient space for a second seat.

In other embodiments, the cart is equipped with a component that includes a work surface, such as a desk with a tablet or other computing device. In this way, a person with otherwise limited mobility can move about an office or other workspace and have the tools needed to work in that space. Other components for an office space include displays, projects, audio equipment, and the like.

In still other embodiments, the cart is equipped with a component that includes a convertible chair, i.e., that is able to convert from an upright chair for working to a reclining chair and even to a bed. As such, the cart can be used to facilitate movement and care for those with limited capabilities.

In yet other embodiments, the cart is equipped to transport and facilitate the use of various tools at a worksite. For example, a table saw component can be attached to the cart, so that the table saw can be moved to and from a worksite and moved around the worksite. The battery of the cart may be used to power the table saw. Other powered hand tools, such as drills, nail guns, and handheld saws may also be transported on the cart. These powered hand tools can be powered by a power cord plugged into the cart or can be recharged on the cart for cordless operation. Preferably, the cart component is also equipped with at least one clamp for holding workpieces, such as a board, while being cut, drilled, etc.

In various exemplary embodiments, the cart includes one or more sensors used by the cart for self-location, navigation, observation, and target identification. In various exemplary embodiments, the cart utilizes GPS, inertial sensors, locally and/or remotely stored maps, and tracking to monitor and track its own position and to determine a path to a destination. In various exemplary embodiments, the cart utilizes cameras, radar, sonar, LiDAR, and the like to detect and avoid obstacles and to detect and navigate to a destination. In some embodiments, the cart is able to receive and process signals from a beacon or the like on a vehicle or docking station in order to locate the source.

In various exemplary embodiments, the cart includes one or more sensors to detect the location of a docking station. In preferred embodiments, the cart includes one or more sensors to determine the orientation (e.g., pitch, roll, and yaw) of a receiver or connector on the docking station in order to position itself for docking and move itself into a docked position. The docking location may also include visual markers or targets, which may be designed for this purpose or may have another purpose (e.g., vehicle license plate). In various exemplary embodiments, the controller includes, or is able to remotely access, AI (artificial intelligence) capability for analyzing camera images to identify and analyze people and objects that it encounters. This may include the ability to recognize In some embodiments, the docking station includes sensors for determining its own orientation (e.g., pitch, roll, and yaw) and wirelessly communicates that information to the cart.

In various exemplary embodiments, the cart is able to store information on its location and movements for use in navigation. This may be stored locally in the cart, on a remote controller, and/or on a cloud service.

In various exemplary embodiments, the cart is programmed to send a notification in the event of problems. These problems may include unexpected shift or loss of cargo detected by weight sensors, an obstructed destination, or lack of a path to a destination. The notification may be sent to a remote-control device, mobile device (e.g., mobile phone), and/or central control system.

Preferably, the cart includes controls on itself for controlling movement and other functions. These controls may include steering wheels or levers, handlebars, buttons, switches, etc. Preferably, the cart is also equipped to receive voice commands. Preferably, the cart is further equipped to receive wireless commands, such as from a smartphone or a smart home system, such as Alexa®, Google Home® or Apple Homepod®.

Various safety features are preferably built into the cart. For example, proximity or other types of sensors can be used to prevent collisions between the cart and other objects. Such sensors may make use of ultrasonic, infrared, optical, radar, lidar or other technology. The level sensors may also be used to avoid tipping conditions.

In various exemplary embodiments, the cart monitors one or more of voltage drop in the arm actuators, current draw in the arm actuators, and wheel motor velocity and uses this data to calculate the weight of the cart and any contents. In some embodiments, the cart includes one or more weight sensors capable of measuring the weight of a load placed on top of the cart. In various exemplary embodiments, motors or actuators used to pivot the arms may be capable of measuring weight load. The angle of the arms may also be used to calculate the height of the body off the ground.

The cart described herein is well-suited to use in combination with the system disclosed in U.S. patent application Ser. No. 17/476,309, entitled “Package Delivery System with Robots for Last Distance,” filed Sep. 15, 2021. The cart of the present disclosure can be used as the robot for taking packages the last distance, for example from a delivery truck to the final destination at a residence or business.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A self-docking cart, comprising:
a body comprising a battery compartment and a platform;
a battery housed in the battery compartment;
a cart docking attachment arm;
a controller;
four arms, each pivotably attached at a first end to the body;
four wheels, each connected to a second end of one of the four arms;
four arm actuators, each configured to pivot one of the four arms such that each wheel can be moved closer to or further away from the body;
wherein the controller adjusts the height of the cart by pivoting one or more of the four arms; and
at least two motors, each configured to rotate one of the four wheels, each independently controlled by the controller, whereby the controller can move the cart and control the yaw of the cart by rotating one or more of the four wheels;
whereby the cart can be moved into an appropriate position and orientation for connecting the docking attachment arm to a docking station by the controller selectively pivoting the arms and rotating the wheels; and
wherein the docking attachment arm comprises connections for electricity or data.

2. The cart of claim 1, further comprising:
at least one sensor for determining the pitch or roll of the cart in communication with the controller, to thereby facilitate the controller adjusting the pitch and roll of the vehicle by controlling the four arm actuators;
at least one targeting sensor for detecting the location, height, pitch, roll, or yaw of a cart docking station receiver whereby the controller can adjust the location, height, pitch, roll, and yaw of the cart to align with the docking station receiver.

3. The cart of claim 1, wherein the cart is docked by rotating the wheels to move the cart and the cart docking attachment arm to engage the docking receiver.

4. The cart of claim 1, wherein the cart is docked by using the arm actuators to adjust the height of the cart and the cart docking attachment arm to engage the docking station receiver.

5. The cart of claim 1, further comprising a locking mechanism for securing the cart docking attachment arm to the docking station receiver.

6. The cart of claim 5, wherein the locking mechanism comprises an automated latch.

7. The cart of claim 1, wherein the arm actuator comprises a linear actuator pivotally attached to the body at a first end and pivotally attached to the arm at a second end.

8. The cart of claim 7, wherein the linear actuator comprises a screw.

9. The cart of claim 1, wherein each of the four arm actuators is independently controlled by the controller.

10. The cart of claim 1, wherein the docking station receiver forms a mechanical connection with the cart.

11. The cart of claim 10, wherein the mechanical connection is able to support the weight of the cart.

12. The cart of claim 1, wherein the cart comprise four motors, each configured to rotate one of the four wheels.

13. The cart of claim 12, wherein each of the four motors are positioned in the hub of one of the four wheels.

14. The cart of claim 1, wherein the wheels comprise Mecanum wheels.

15. The cart of claim 1, wherein the at least one level sensor comprises a pitch level sensor and a roll level sensor.

16. The cart of claim 1, wherein the at least one targeting sensor comprises a camera.

17. The cart of claim 1, wherein the at least one targeting sensor comprises a proximity sensor.

18. The cart of claim 1, wherein the at least one targeting sensor detects a beacon signal from the docking station.
